(19) United States
(12) Patent Application Publication
(10) Pub. No.: US 2026/0240254 A1
(43) Pub. Date: Aug. 20, 2026

(54) AEROSOL PROVISION SYSTEM COMPRISING A TOKEN WITH A COMMUNICATOR

(71) Applicant: Nicoventures Trading Limited, London (GB)

(72) Inventor: Zhihuang XIAO, London (GB)

(21) Appl. No.: 19/161,762

(22) PCT Filed: Feb. 29, 2024
(86) PCT No.: PCT/EP2024/055288

§ 371 Date: Sep. 3, 2025

(30) Foreign Application Priority Data
Mar. 3, 2023 (GB) 2303188.3

(51) Int. Cl. A24F 40/53; A24F 40/65; G06F 21/34

(52) U.S. Cl. CPC A24F 40/53; A24F 40/65; G06F 21/34

(57) ABSTRACT

An aerosol provision system comprising an aerosol provision device for generating aerosol from aerosol generating material, the aerosol provision device comprising: a processor; and a device communicator, wherein the aerosol provision system comprises a token, the token comprising a token communicator, wherein the token communicator is configured to transmit an unlock signal to the device communicator, wherein the processor is configured to unlock the aerosol provision device from a locked state in response to the device communicator receiving the unlock signal.

### TECHNICAL FIELD

The present invention relates to an aerosol provision device and an aerosol provision system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with a first aspect, there is provided an aerosol provision system comprising an aerosol provision device for generating aerosol from aerosol generating material, the aerosol provision device comprising: a processor; and a device communicator, wherein the aerosol provision system comprises a token, the token comprising a token communicator, wherein the token communicator is configured to transmit an unlock signal to the device communicator, wherein the processor is configured to unlock the aerosol provision device from a locked state in response to the device communicator receiving the unlock signal.

The token may be a wearable component.

The wearable component may be a ring. The wearable component may be a bracelet. The wearable component may be a watch.

The token may be a key. The token may be a keyring. The token may be a card.

The device communicator may be a first NFC communicator. The token communicator may be a second NFC communicator.

The token communicator may be an active NFC communicator. The device communicator may be a passive NFC communicator.

The token may comprise a memory to store an identifier of the token.

The unlock signal may comprise an identifier configured to identify the token. The unlock signal may be encrypted.

The unlock signal may comprise a passcode, the processor configured to unlock the aerosol provision device from a locked state in response to the device communicator receiving the passcode

The token communicator may be configured to transmit the unlock signal periodically. The token communicator may be configured to transmit the unlock signal with an unlock signal period, wherein the unlock signal period is less than 30 s.

The unlock signal may be receivable by the device communicator when the token is within a detection distance of the aerosol provision device.

The detection distance may be less than 20 cm. The detection distance may be less than 15 cm. The detection distance may be less than 12 cm. The detection distance may be less than 11 cm. The detection distance may be substantially 10 cm.

The token may be reusable with a plurality of aerosol provision devices.

The processor may be configured to maintain the aerosol provision device in an unlocked state for a predetermined time period in response to the unlocking user input being received by the user input element. The processor may be configured to revert the aerosol provision device to the locked state after the predetermined time period.

The processor may be configured to maintain the aerosol provision device in an unlocked state for a predetermined number of uses in response to the unlocking user input being received by the user input element. The processor may be configured to revert the aerosol provision device to the locked state after the predetermined number of uses.

The predetermined number of uses may be a predetermined number of puffs.

The predetermined number of uses may be a predetermined number of sessions of use. The predetermined number of sessions of use may be one session of use. The processor may be configured to revert the aerosol provision device to the locked state in response to the session of use ending.

The processor may be configured to maintain the aerosol provision device in an unlocked state indefinitely in response to the unlocking user input being received by the user input element.

The processor may be configured to initiate a session of use of the aerosol provision device after unlocking the aerosol provision device from the locked state.

The processor may be configured to prevent an aerosol generator from being energised when the aerosol provision device is in the locked state.

The aerosol provision device may comprise the aerosol generating material.

According to a second aspect, there is provided a token for an aerosol provision system, the token comprising a token a communicator, the token communicator configured to transmit an unlock signal to a device communicator of an aerosol provision device to unlock the aerosol provision device from a locked state. The token may comprise any of the features described with respect to the first aspect.

According to a third aspect there is provided an aerosol provision device for generating aerosol from aerosol generating material, the aerosol provision device comprising: a processor; and a device communicator configured to receive an unlock signal from a token communicator of a token, wherein the processor is configured to unlock the aerosol provision device from a locked state in response to the device communicator receiving the unlock signal. The aerosol provision device may comprise any of the features described with respect to the first aspect.

According to a fourth aspect there is provided a method of operating an aerosol provision system, the method comprising: transmitting an unlock signal from a token to an aerosol provision device; and unlocking the aerosol provision device from a locked state in response to the unlock signal being received. The method may comprise any of the features and/or functional steps described with respect to the first aspect.

### BRIEF DESCRIPTION OF THE DRAWINGS

Embodiments will now be described, by way of example only, and with reference to the accompanying drawings in which:

FIG. 1 shows a view of an aerosol provision system;

FIG. 2 shows a schematic of the aerosol provision system; and

FIG. 3 shows a method of operating an aerosol provision system.

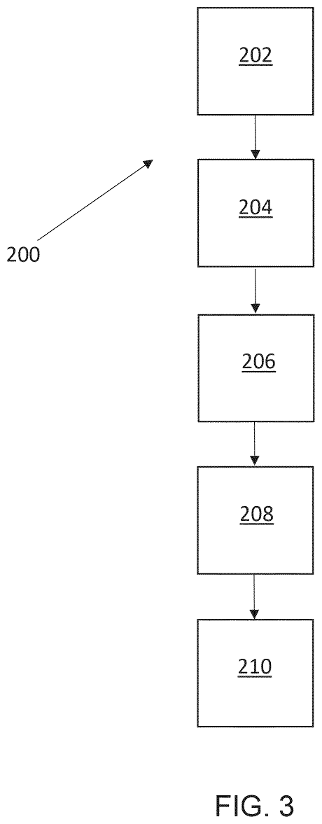

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine.

Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

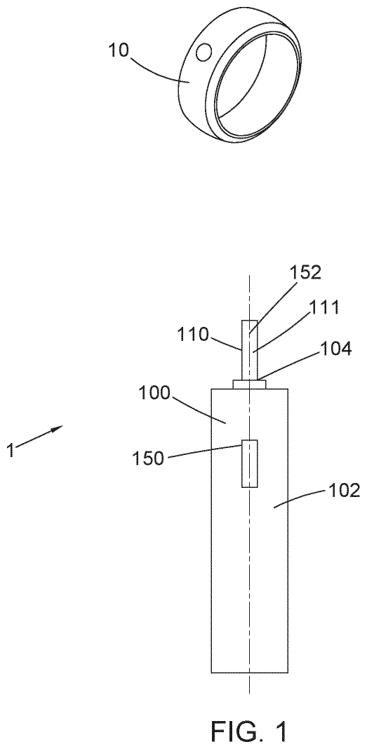

With reference to FIG. 1, an aerosol provision system 1 comprises an aerosol provision device 100 for generating aerosol from an aerosol generating material. The aerosol provision system 1 further comprises a replaceable article 110 comprising the aerosol generating material. In broad outline, the aerosol forming device 100 may be used to heat the article 110 to generate an aerosol or other inhalable medium, which is inhaled by a user of the device 100.

The aerosol provision system 1 comprises a token 10. The token 10 is a wearable component. In the present example, the token 10 is a ring and is wearable on a finger of the user. In other examples, the token 10 may be a different wearable component, for example, a bracelet fir wearing on a wrist of the user. In other examples, the token 10 is not wearable, but is a card or other key that may be carried by the user. The token 10 is a separate component from the aerosol provision device 100. The token 10 is not comprised in the aerosol provision device 100.

The aerosol forming device 100 comprises a body 102. A housing arrangement surrounds and houses various components of the body 102. An article aperture 104 is formed at one end of the body 102, through which the article 110 may be inserted for heating by an aerosol generator 116.

The device 100 may also include a user-operable control element 150, such as a button or switch, which operates the device 100 when pressed. For example, a user may turn on the device 100 by operating the switch 150.

The aerosol generator 116 defines a longitudinal axis, which aligns with an axis of the article 110.

In use, the article 110 may be fully or partially inserted into the aerosol generator 116 where it may be heated by one or more components of the aerosol generator 166.

The device 100 includes an apparatus for heating aerosol-generating material. The apparatus includes an aerosol generator, a controller (control circuit), and a power source. The apparatus forms part of the body 102. The aerosol generator is configured to heat the aerosol-generating material of an article 110 inserted through the article aperture 104, such that an aerosol is generated from the aerosol generating material. The power source supplies electrical power to the aerosol generator, and the aerosol generator converts the supplied electrical energy into heat energy for heating the aerosol-generating material. The power source may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source may be electrically coupled to the aerosol generator to supply electrical power when required and under control of the controller to heat the aerosol generating material. The control circuit may be configured to activate and deactivate the aerosol generator based on a user input. The user input may be via a button press or opening a door of the device (for example, a door covering a consumable receiving receptacle). The control circuit may be configured to activate and deactivate automatically, for example on insertion of an article.

The aerosol generator may comprise various components to heat the aerosol generating material via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

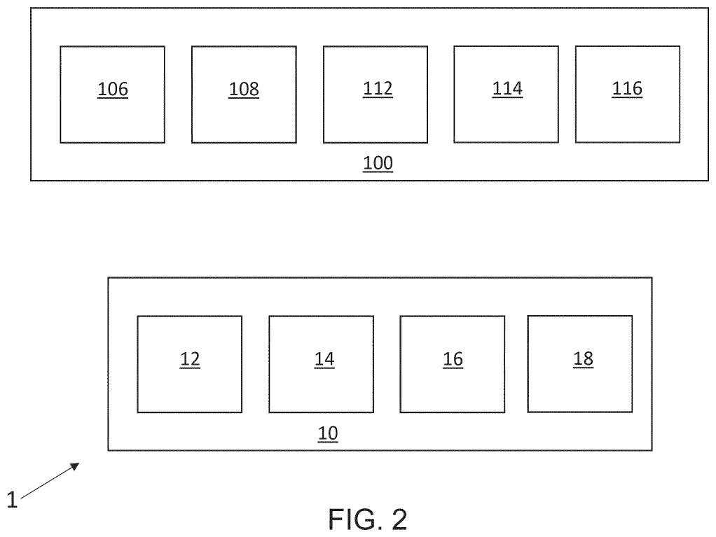

With reference to FIG. 2, there is shown a schematic drawing of the aerosol provision device 100 and the token 10.

The aerosol provision device further 100 further comprises a device processor 106, a first device communicator 108, a second device communicator 112, a device energy storage 114 and the aerosol generator 116. The device energy storage 114 is a power source as described above.

The token 10 comprises a token communicator 12, a memory 14, a token processor 16 and a token energy storage 18. The token energy storage 18 is a battery.

The token communicator 12 is configured to communicate with the first device communicator 108. The token communicator 12 is a near field communication (NFC) communicator. The first device communicator 108 is a NFC communicator.

The first device communicator 108 is a passive NFC communicator (i.e. is configured to take energy form the signal received from the token communicator 12 and use the energy to send a return signal to the first device communicator). The token communicator 12 is an active NFC communicator (i.e. is configured to use energy from the token energy storage 18 to transmit a signal to the token communicator). In some examples, the first device communicator and the token communicator may be reversed, with the token communicator 12 being a passive NFC communicator and the first device communicator being an active NFC communicator.

The second device communicator 112 is configured to communicate with an external device (not shown), for example, a mobile device. The second device communicator 112 is a Bluetooth communicator.

The memory 14 is configured to store an identifier which identifies the token 10. The memory 14 is further configured to store an unlock signal, as explained below.

With reference to FIG. 2, there is shown a method 200 of operating the aerosol provision system 1. The method 200 comprises a user registration step 202, an unlock signal transmitting step 204, an unlock signal receiving step 206, an aerosol generation step 208 and a locking step 210.

In the user registration step 202, the user purchases the aerosol provision device 100. The user performs a registration process to confirm the user's age meets an age requirement. The registration process may be a web registration process. During the user registration step 202, the identifier of the token 10 is assigned to a profile of the user.

During the user registration step 202, the aerosol provision device 100 is assigned to the profile of the user. The aerosol provision device 100 may be configured to transmit a device identifier to an external device (e.g. a mobile device, store terminal or other computer) via the second device communicator 112.

During the user registration step 202, a passcode is transmitted to the token 10. The passcode is stored in the memory 14. The passcode is unique to the aerosol provision device 100. The passcode is determined during the registration process in response to the device identifier. The passcode is transmitted to the token 10 via the token communicator 12.

The aerosol provision device 100 is in a locked state. In the locked state the device processor 106 does not transmit energy from the device energy storage 114 to the aerosol generator 116. The aerosol generator 116 does not generate aerosol.

In the unlock signal transmitting step 204, the token communicator 12 transmits the unlock signal comprising the passcode. The token communicator 12 transmits the unlock periodically with an unlock signal period. The unlock signal period is less than 30 s. More specifically, the unlock signal period is less than 1 s, substantially 10 ms.

When the aerosol provision device 100 is further than a detection distance from the token 10, the unlock signal is not received by the aerosol provision device 100 and the aerosol provision device 100 remains in the locked state. The detection distance is less than 20 cm, more specifically less than 15 cm, more specifically less than 12 cm, more specifically less than 11 cm, more specifically substantially 10 cm. In some examples the detection distance may be longer than 10 cm, which may be easier for a user. However, a longer detection distance may increase power consumption.

When the token 10 is brought within the detection distance of the aerosol provision device 100, the first device communicator 108 receives the unlock signal in the unlock signal receiving step 206. In response to the unlock signal comprising the passcode being received, the device processor 106 unlocks the aerosol provision device 100 from the locked state. The aerosol provision device 100 enters the unlocked state, in which activation of the aerosol generator 116 is permitted.

In the aerosol generation step 208, the device processor 106 controls the aerosol generator 116 to generate aerosol. The device processor 106 controls the device energy storage 114 to provide power to the aerosol generator 116 to generate aerosol.

In the present example, the device processor 106 is configured to initiate a session of use (in which aerosol generating material is heated and the user may take a plurality of inhales) in response to the unlock signal being received. In other examples, a further user input (e.g. a button press) is required to cause aerosol generation.

In the locking step 210, the device processor 106 returns the aerosol provision device 100 to the locked state. In the present example, the device processor 106 returns the aerosol provision device 100 to the locked state after a predetermined number of uses, which is at the end of the session of use (i.e. the predetermined number of uses is a single session of use). In other examples, the device processor may return the aerosol provision device to the locked state after a predetermined time period expires. In other examples, the locking step 210 may not take place and the aerosol provision device 100 may remain in the unlocked state.

The token 10 may be reusable for a plurality of aerosol provision devices by repeating the method 200 and storing a new passcode in the token memory 14 in a further user registration step 202. This may be particularly advantageous where the aerosol provision device is a disposable device (e.g. a disposable vaping device) designed to run for a predetermined number of sessions before disposal.

In the above described embodiments, the aerosol provision device comprises a heating arrangement that is an inductive heating arrangement. In embodiments, other types of heating arrangement are used, such as resistive heating. The configuration of the device is generally as described above and so a detailed description will be omitted. In such arrangements the aerosol generator comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision system comprising an aerosol provision device for generating aerosol from aerosol generating material, the aerosol provision device comprising:
a processor; and
a device communicator,
wherein the aerosol provision system comprises a token, the token comprising a token communicator,
wherein the token communicator is configured to transmit an unlock signal to the device communicator,
wherein the processor is configured to unlock the aerosol provision device from a locked state in response to the device communicator receiving the unlock signal.

2. An aerosol provision system according to claim 1, wherein the token is a wearable component.

3. An aerosol provision system according to claim 2, wherein the wearable component is a ring.

4. An aerosol provision system according to claim 1, wherein the token is a key and/or a card.

5. An aerosol provision system according to claim 1, wherein the device communicator and the token communicator comprise NFC communicators.

6. An aerosol provision system according to claim 5, wherein the token communicator is an active NFC communicator.

7. An aerosol provision system according to claim 1, wherein the unlock signal comprises a passcode, the processor configured to unlock the aerosol provision device from a locked state in response to the device communicator receiving the passcode.

8. An aerosol provision system according to claim 1, wherein the unlock signal is encrypted.

9. An aerosol provision system according to claim 1, wherein the token communicator is configured to transmit the unlock signal periodically.

10. An aerosol provision system according to claim 9, wherein the token communicator is configured to transmit the unlock signal with an unlock signal period, wherein the unlock signal period is less than 30 s.

11. An aerosol provision system according to claim 1, wherein the unlock signal is receivable by the device communicator when the token is within a detection distance of the aerosol provision device.

12. An aerosol provision system according to claim 1, wherein the token is reusable with a plurality of aerosol provision devices.

13. An aerosol provision system according to claim 1, wherein the processor is configured to maintain the aerosol provision device in an unlocked state for a predetermined time period or predetermined number of uses in response to the unlocking user input being received by the user input element

14. An aerosol provision system according to claim 13, wherein the processor is configured to revert the aerosol provision device to the locked state after the predetermined time period or predetermined number of uses.

15. An aerosol provision system according to claim 1, wherein the processor is configured to maintain the aerosol provision device in an unlocked state indefinitely in response to the unlocking user input being received by the user input element.

16. An aerosol provision system according to claim 1, wherein the processor is further configured to initiate a session of use of the aerosol provision device after unlocking the aerosol provision device from the locked state.

17. An aerosol provision system according to claim 1, and comprising an article, the article comprising the aerosol generating material.

18. A token for an aerosol provision system, the token comprising a token a communicator, the token communicator configured to transmit an unlock signal to a device communicator of an aerosol provision device to unlock the aerosol provision device from a locked state.

19. (canceled)

20. A method of operating an aerosol provision system, the method comprising:
transmitting an unlock signal from a token to an aerosol provision device; and
unlocking the aerosol provision device from a locked state in response to the unlock signal being received.
